(19) United States
(12) Patent Application Publication
(10) Pub. No.: US 2009/0327603 A1
(43) Pub. Date: Dec. 31, 2009

(54) System including solid state drives paired with hard disk drives in a RAID 1 configuration and a method for providing/implementing said system

(76) Inventors: Brian McKean, Longmont, CO (US); Dennis Kleppen, Golden, CO (US)

Correspondence Address: LSI Corporation c/o Suiter Swantz pc llo, 14301 FNB Parkway, Suite 220, Omaha, NE, 68154, US

(21) Appl. No.: 12/215,290

(22) Filed: Jun. 26, 2008

(51) Int. Cl. G06F 12/00

(52) U.S. Cl. 711/114; 711/E12.001

(57) ABSTRACT

The present invention is a storage system. The storage system includes a disk array. The disk array includes a disk drive pair which includes a hard disk drive and a solid state disk drive, such as a NAND flash drive. The storage system also includes a disk array controller. The disk array controller may be communicatively coupled with a host server and with the disk array. Further, the disk array controller may be configured for reading from the disk array and writing to the disk array based upon read commands and write commands received from the host server. The disk array may be configured as a Redundant Array of Inexpensive Disks (RAID) configuration, such as a Level 1 RAID configuration (RAID 1). Thus, the disk drive pair may be a RAID disk drive pair, such as a RAID 1 disk drive pair. Further, all the read commands may be directed exclusively to the solid state disk drive and the write commands may be directed to both the solid state disk drive and the hard disk drive.

### FIELD OF THE INVENTION

The present invention relates to the field of electronic data storage and particularly to a system which includes solid state drives paired with hard disk drives in a RAID 1 (Redundant Array of Inexpensive Disks) configuration and a method for providing/implementing said system.

### BACKGROUND OF THE INVENTION

A first group of currently available storage systems for providing redundancy may not provide a desired level of performance. A second group of currently available storage systems for providing redundancy, despite providing a higher level of performance than the first group of currently available storage systems, may not be cost-effective to implement.

Therefore, it may be desirable to provide a storage system which addresses the above-referenced problems of currently available storage system solutions.

### SUMMARY OF THE INVENTION

Accordingly, an embodiment of the present invention is directed to a storage system, including a disk array, the disk array including a disk drive pair, the disk drive pair including a solid state disk drive and a hard disk drive; and a disk array controller, the disk array controller configured for being communicatively coupled with the disk array and a host server, the disk array controller being further configured for reading from the disk array and writing to the disk array based upon commands received from the host server, wherein the disk array is provided as a Redundant Array of Inexpensive Disks (RAID) configuration, the disk drive pair being a RAID disk drive pair.

A further embodiment of the present invention is directed to a method for implementing a storage system, the storage system including a disk array, the disk array including a disk drive pair, the disk drive pair including a solid state disk drive and a hard disk drive, said method including: receiving read commands and write commands from a host server; directing the read commands exclusively to the solid state disk drive; directing the write commands to the hard disk drive and the solid state disk drive; and reading data from the solid state disk drive based upon the read commands, wherein the disk array is configured as a Redundant Array of Inexpensive Disks (RAID) configuration, with the disk drive pair being a RAID disk drive pair.

An additional embodiment of the present invention is directed to a computer-readable medium having computer-executable instructions for performing a method for implementing a storage system, the storage system including a disk array, the disk array including a disk drive pair, the disk drive pair including a solid state disk drive and a hard disk drive, said method including: receiving read commands and write commands from a host server; directing the read commands exclusively to the solid state disk drive; directing the write commands to the hard disk drive and the solid state disk drive; and reading data from the solid state disk drive based upon the read commands, wherein the disk array is configured as a Redundant Array of Inexpensive Disks (RAID) configuration, with the disk drive pair being a RAID disk drive pair.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram of a storage system in accordance with an exemplary embodiment of the present invention;

FIG. 2 is an illustration of a physical disk drive data layout for the first disk drive of the disk drive pair of the storage system shown in FIG. 1, a physical disk drive data layout for the second disk drive of the disk drive pair of the storage system shown in FIG. 1, and a virtual disk drive data layout for the disk drive pair of the storage system shown in FIG. 1, when the disk drive pair is a mirrored (ex. —RAID 1) pair in accordance with an exemplary embodiment of the present invention;

FIG. 3 is a block diagram of a storage system in accordance with a further exemplary embodiment of the present invention, said storage system implementing hot spare disk drives;

FIG. 4 is a block diagram of the storage system shown in FIG. 3, in which data is being copied from a solid state disk drive of the storage system to a hot spare disk drive of the storage system in response to a preemptive failure warning signal, in accordance with an exemplary embodiment of the present invention; and

FIG. 5 is a flow chart illustrating a method for implementing a storage system of the present invention, in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

Redundancy for disk array controllers may be achieved through implementation of Redundant Array of Inexpensive Disks (RAID) technology and similar types of disk drives. For example, Level 1 RAID (RAID 1) may involve creating/implementing a mirrored pair of disk drives. Often, disk drives of similar size/storage capacity and having similar performance levels are paired. Hard disk drives of the same disk drive class will often have similar read and write performances. For example, a hard disk drive having a 15,000 revolutions per minute (rpm) spindle speed will generally perform similarly to another hard disk drive with the same spindle speed. Alternatively, a hard disk drive having a 15,000 revolutions per minute (rpm) spindle speed will generally perform much better than a hard disk drive having a 7,200 rpm spindle speed.

One possible storage system which may be created/implemented involves implementing a mirrored pair of disk drives which includes a hard disk drive and a Dynamic Random Access Memory (DRAM)-based storage device/disk drive. For example, the system may mirror data written to both the DRAM-based disk drive and the hard disk drive. Further, said system may include a disk array controller which may be configured to direct all reads to the DRAM-based disk drive. However, during a power cycle, the DRAM-based disk drive of said system may lose data. After the power cycle, the disk array controller may read data from the hard disk drive and load the DRAM-based disk drive. Further, while the DRAM-based disk drive of said mirrored pair of disk drives may provide high write performance, the overall write performance of said system/said mirrored pair of disk drives may be limited by the write performance of the hard disk drive, which may typically be much lower than that of DRAM-based disk drives.

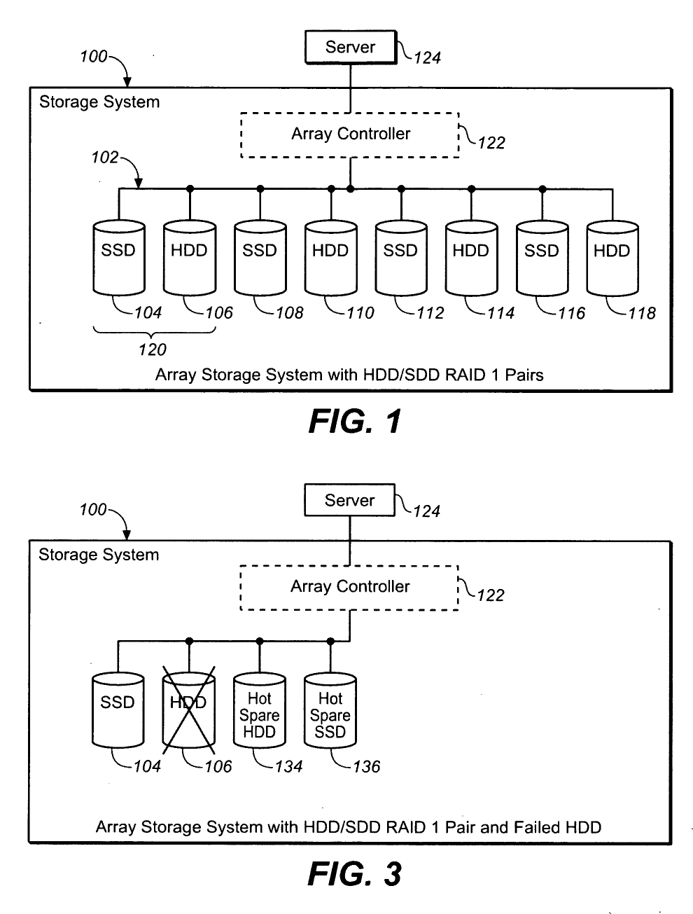

Referring to FIG. 1, a storage system in accordance with an exemplary embodiment of the present invention is shown. The storage system 100 may include a disk array 102. For example, the disk array 102 may include a plurality of disk drives (104, 106, 108, 110, 112, 114, 116, 118). Further, the disk array 102 may be provided/configured as a Redundant Array of Inexpensive Disks (RAID) configuration. For instance, the disk array 102 may be configured as a Level 1 RAID configuration (RAID 1 configuration)/RAID 1 redundancy group(s).

In current embodiments of the present invention, at least two disk drives (ex. —104 and 106) included in the plurality of disk drives (104, 106, 108, 110, 112, 114, 116, 118) may form a disk drive set/disk drive pair 120. For example, the disk drive pair 120 may be configured as a RAID 1 disk drive pair, with a first disk drive 104 of the disk drive pair 120 mirroring data of (ex. —storing a same set of data as) a second disk drive 106 of the disk drive pair 120. Further, multiple disk drive sets/pairs (ex. —multiple RAID 1 disk drive pairs) may be formed by disk drives included in the plurality of disk drives.

In additional embodiments of the present invention, the storage system 100 may include a disk array controller 122. The disk array controller 122 may be configured for being communicatively coupled with the disk array 102. Further, the disk array controller 122 may be configured for being communicatively coupled with a host server 124. The disk array controller 122 may be configured for managing distribution of data across the plurality of disk drives (104, 106, 108, 110, 112, 114, 116, 118) of the disk array 102. The disk array controller 122 may perform said data distribution management in response to commands (ex. —read commands, write commands) received by the disk array controller 122 from the host server 124. In exemplary embodiments, the disk array controller 122 may be a hardware/hardware-based disk array controller 122. In further embodiments, the disk array controller 122 may be a software/software-based/operating system-based disk array controller 122. In still further embodiments, the disk array controller 122 may be a firmware/driver-based disk array controller 122.

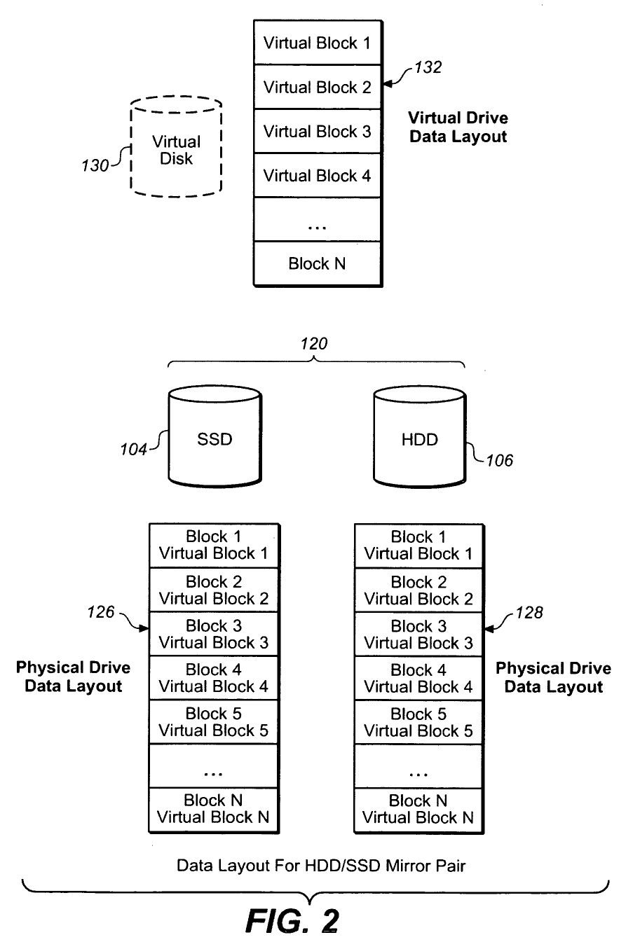

FIG. 2 illustrates a physical disk drive data layout 126 for the first disk drive 104 of the disk drive pair 120 and a physical disk drive data layout 128 for the second disk drive 106 of the disk drive pair 120 when the disk drive pair 120 is a mirrored (ex. —RAID 1) pair. When the disk array 102 and the disk drive pair 120 are configured as RAID 1, if a disk drive of the disk drive pair 120 fails (ex. —due to a hardware or software malfunction), the RAID 1 configuration may prevent data from being lost from the disk drive set/pair 120 as long as one disk of the disk drive set/pair/mirrored pair 120 remains functional. In the illustrated embodiment, the disk drive pair 120 (and/or the disk array 102) may be viewed by/perceived by/treated by the host server 124 as a single, virtual disk drive 130 having a virtual disk drive data layout 132 as shown in FIG. 2. Still further, the total storage capacity of the disk array 102 is limited to a value equal to a storage capacity value for the lowest storage capacity disk drive of the disk array 102.

In exemplary embodiments of the present invention, the first disk drive 104 of the disk drive pair 120 may be a solid state disk drive 104. For example, the solid state disk drive 104 may be flash drive, such as a Not and (NAND) flash drive 104. Further, the second disk drive 106 of the disk drive pair 120 may be a hard disk drive 106. NAND flash drives may characteristically have much greater random read performance than the hard disk drives. Although random write performance for NAND flash drives may range from being much worse to much greater than random write performance of hard disk drives, NAND flash drives are characteristically far superior to hard disk drives in terms of random read performance (ex. —100 times faster/better random read performance than hard disk drives).

In current embodiments of the present invention, the disk array controller 122 may be configured for directing write commands to/writing data to/causing data to be written to the disk drive pair 120/disk array 102 based upon commands received from the host server 124. For instance, when the disk drive pair 120 is a mirrored pair, such as a RAID 1 pair, any data which is written to the first disk drive/solid state disk drive 104 (ex. —the NAND flash drive) is also written to the second disk drive/hard disk drive 106. Consequently, the disk drive pair 120/disk array 102 is limited in its write performance by the speed of the slowest performing disk drive (ex. —the disk drive having the lesser write performance) of the disk drive pair/set 120.

In additional embodiments of the present invention, the disk array controller 122 may be configured for directing read commands to/reading data from/causing data to be read from the disk array 102 based upon commands received from the host server 124. For example, when the disk drive pair 120 of the disk array 102 is a mirrored pair, such as a RAID 1 pair, the disk array controller 122 may be configured for directing read commands exclusively to/reading data exclusively from/causing data to be read exclusively from the solid state disk drive 104 (ex. —the NAND flash drive). By directing all reads/read commands exclusively to and reading data exclusively from the NAND flash drive 104 of the disk drive pair 120 (ex. —RAID 1 pair), the storage system 100 of the present invention may take advantage of the typically much higher read performance of solid state disk drives/NAND flash drives as compared to the read performance of the hard disk drive 106, thereby allowing the disk drive pair 120 (or pairs) of the disk array 102 of the present invention to provide superior read performance compared to disk drive pairs/sets, disk arrays which implement only hard disk drives.

Although solid state disk drives (ex. —NAND flash drives) may provide the advantage of far superior read performance (ex. —faster reads) compared to hard disk drives, the solid state disk drives are often much more expensive per unit of capacity than hard disk drives. However, the present invention, by configuring a disk array 102 which may implement hard disk drive/solid state disk drive pairs 120, is much less expensive than implementing a RAID disk array with similar user available capacity which includes only solid state disk drives/solid state disk drive pairs/solid state disk drive groups, such as a Level 5 RAID (RAID 5) solid state disk group/array. Further, the disk array 102 (ex. —RAID 1 configuration) of the present invention may provide better performance (ex. —100 times better random read performance, same write performance) and reliability than a RAID disk array, such as a RAID 5 disk array with similar user available capacity, which implements only solid state disk drives/groups/sets/pairs.

In further embodiments, the solid state disk drive/NAND flash drive 104 and the hard disk drive 106 of the disk drive pair 120 may be performance-matched with respect to random write performance and storage capacity for promoting a decreased cost-to-performance ratio for the storage system 100. For example, a NAND flash drive 104 may be selected and paired with a hard disk drive 106, such that the NAND flash drive 104 and the hard disk drive 106 have a similar storage capacity and random write performance (since writes will be directed to both the NAND flash drive 104 and the hard disk drive 106).

In alternative embodiments, the solid state disk drive 104 of the disk drive pair 120 may implement Dynamic Random Access Memory (DRAM) and/or Static Random Access Memory (SRAM).

In exemplary embodiments, the disk array 102 may include one or more replacement disk drives (134, 136), such as hot spare disk drives. For example, as shown in FIG. 3, the disk array 102 may include a hot spare hard disk drive 134 and a hot spare solid state disk drive 136. As discussed above, the system 100 of the present invention is configured for directing all reads/read commands/read operations exclusively to the solid state disk drive 104 (ex. —the NAND flash drive) of the disk drive pair 120 and is further configured for directing the writes/write commands/write operations to both the solid state disk drive 104 and the hard disk drive 106 of the disk drive pair 120. Consequently, when the hard disk drive 106 of the disk drive pair 120 fails (as shown in FIG. 3), if the solid state disk drive 104 remains functional, the performance of the storage system 100 is resistant to degradation/loss since the solid state disk drive 104 may continue to perform/service reads and writes (since said solid state disk drive 104 was already performing/servicing all of the reads/read commands prior to the failure and the write commands/writes were also already being serviced/performed by the solid state disk drive 104 (along with the hard disk drive 106) prior to the failure). and, in the system 100 of the present invention, all reads/read commands would already be exclusively directed to the solid state disk drive 104 (ex. —NAND flash drive) of the disk drive pair 120 prior to the failure of the hard disk drive 106. After a failure of a disk drive of the disk array 102 has occurred, such as the failure of the hard disk drive 106 as shown in FIG. 3, the disk array controller 122 may be configured for directing the process of rebuilding data to the replacement drive(s), such as the hot spare hard disk drive 134. Because of the above-referenced capability of the solid state disk drive 104 of the system 100 of the present invention to perform/service both the reads/read commands and writes/write commands for the disk drive pair 120 when the hard disk drive 106 has failed, rebuilding to the replacement/hot spare hard disk drive 134 may be much quicker than an equivalent rebuild on a RAID 5 solid state disk array, as the mirrored disk drive pair 120 (ex—RAID 1 mirrored pair) would require far fewer operations to complete rebuild.

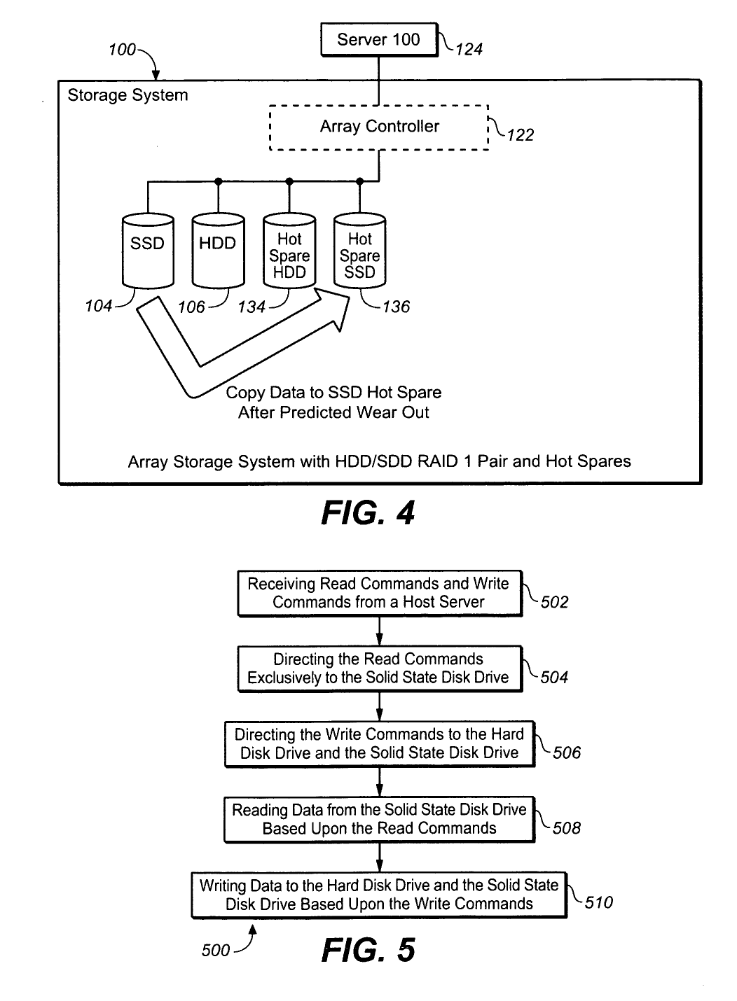

In current embodiments of the present invention, the solid state disk drive 104 (ex. —NAND flash drive) of the disk drive pair 120 (ex. —RAID 1 pair) may be configured for monitoring a failure mode of the solid state disk drive 104, such as wear-out (ex. —wear-out due to expiration of program/erase cycles). Further, the solid state disk drive 104 may be configured for providing a preemptive warning of wear-out (ex. —a preemptive failure warning signal) to the system 100 (ex. —to the disk array controller 122) to indicate that the solid state disk drive 104 is approaching the end of its useful life (ex. —is about to fail). Further, in response to the preemptive failure warning signal, the disk array controller 122 may be configured for facilitating/directing/initiating copying of data from the solid state disk drive 104 (ex. —the failing disk drive) of the disk drive pair 120 to a replacement disk drive, such as the hot spare solid state disk drive 136 (as shown in FIG. 4), thereby allowing the disk array controller 122 to take preemptive measures prior to failure of the solid state disk drive 104 of the disk drive pair 120. Further, once copying of the data from the failing solid state disk drive 104 to the hot spare solid state disk drive 136 is complete, the storage system 100 (ex. —the disk array controller 122) is configured for automatically replacing/swapping out the solid state disk drive 104 of the disk drive pair 120 with/for the hot spare solid state disk drive 136, thereby pairing the hot spare solid state disk drive 136 with the hard disk drive 106, the hot spare solid state disk drive 136 including the copied data from the solid state disk drive 104.

FIG. 5 is a flowchart illustrating a method for implementing a storage system in accordance with an exemplary embodiment of the invention. The method 500 may include receiving read commands and write commands from a host server 502. The method 500 may further include directing the read commands exclusively to the solid state disk drive 504. The method 500 may further include directing the write commands to the hard disk drive and the solid state disk drive 506. The method 500 may further include reading data from the solid state disk drive based upon the read commands, wherein the disk array is configured as a Redundant Array of Inexpensive Disks (RAID) configuration, with the disk drive pair being a RAID disk drive pair 508. The method 500 may further include writing data to the hard disk drive and the solid state disk drive based upon the write commands 510. The method 500 may further include copying data from the solid state disk drive to a hot spare solid state disk drive in response to a preemptive failure warning signal provided by the solid state disk drive 512. The method 500 may further include replacing the solid state disk drive of the disk drive pair with the hot spare solid state disk drive, thereby pairing said hot spare solid state disk drive with said hard disk drive, said hot spare solid state disk drive including the copied data from the solid state disk drive 514.

The system 100 and method 500 of the present invention may be implemented in a variety of RAID storage products/storage systems and/or in any product/storage system implementing embedded storage.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A storage system, comprising:
a disk array, the disk array including a disk drive pair, the disk drive pair including a solid state disk drive and a hard disk drive; and
a disk array controller, the disk array controller configured for being communicatively coupled with the disk array and a host server, the disk array controller being further configured for reading from the disk array and writing to the disk array based upon commands received from the host server,
wherein the disk array is provided as a Redundant Array of Inexpensive Disks (RAID) configuration, the disk drive pair being a RAID disk drive pair.

2. A storage system as claimed in claim 1, wherein the RAID configuration is a Level 1 RAID configuration (RAID 1 configuration) and the RAID disk drive pair is a RAID 1 disk drive pair.

3. A storage system as claimed in claim 2, wherein the solid state disk drive is a flash drive.

4. A storage system as claimed in claim 3, wherein the solid state disk drive is a Not and (NAND) flash drive.

5. A storage system as claimed in claim 1, wherein the disk array further includes a hot spare solid state disk drive.

6. A storage system as claimed in claim 5, wherein the solid state disk drive is configured for providing a preemptive failure warning signal.

7. A storage system as claimed in claim 6, wherein the disk array controller, in response to the preemptive failure warning signal, is configured for facilitating copying of data from the solid state disk drive to the hot spare solid state disk drive.

8. A storage system as claimed in claim 7, wherein the storage system is configured for automatically replacing the solid state disk drive of the disk drive pair with the hot spare solid state disk drive, thereby pairing said hot spare solid state disk drive with said hard disk drive, said hot spare solid state disk drive including the copied data from the solid state disk drive.

9. A storage system as claimed in claim 1, wherein the solid state disk drive implements at least one of Dynamic Random Access Memory (DRAM) or Static Random Access Memory (SRAM).

10. A method for implementing a storage system, the storage system including a disk array, the disk array including a disk drive pair, the disk drive pair including a solid state disk drive and a hard disk drive, said method comprising:
receiving read commands and write commands from a host server;
directing the read commands exclusively to the solid state disk drive;
directing the write commands to the hard disk drive and the solid state disk drive; and
reading data from the solid state disk drive based upon the read commands,
wherein the disk array is configured as a Redundant Array of Inexpensive Disks (RAID) configuration, with the disk drive pair being a RAID disk drive pair.

11. A method as claimed in claim 10, further comprising:
writing data to the hard disk drive and the solid state disk drive based upon the write commands.

12. A method as claimed in claim 11, further comprising:
copying data from the solid state disk drive to a hot spare solid state disk drive in response to a preemptive failure warning signal provided by the solid state disk drive.

13. A method as claimed in claim 12, further comprising:
replacing the solid state disk drive of the disk drive pair with the hot spare solid state disk drive, thereby pairing said hot spare solid state disk drive with said hard disk drive, said hot spare solid state disk drive including the copied data from the solid state disk drive.

14. A method as claimed in claim 10, wherein the RAID configuration is a Level 1 RAID configuration (RAID 1 configuration) and the RAID disk drive pair is a RAID 1 disk drive pair.

15. A method as claimed in claim 10, wherein the solid state disk drive is a Not and (NAND) flash drive.

16. A computer-readable medium having computer-executable instructions for performing a method for implementing a storage system, the storage system including a disk array, the disk array including a disk drive pair, the disk drive pair including a solid state disk drive and a hard disk drive, said method comprising:
receiving read commands and write commands from a host server;
directing the read commands exclusively to the solid state disk drive;
directing the write commands to the hard disk drive and the solid state disk drive; and
reading data from the solid state disk drive based upon the read commands; and
writing data to the hard disk drive and the solid state disk drive based upon the write commands,
wherein the disk array is configured as a Redundant Array of Inexpensive Disks (RAID) configuration, with the disk drive pair being a RAID disk drive pair.

17. A computer-readable medium as claimed in claim 16, said method further comprising:
copying data from the solid state disk drive to a hot spare solid state disk drive in response to a preemptive failure warning signal provided by the solid state disk drive.

18. A computer-readable medium as claimed in claim 17, said method further comprising:
replacing the solid state disk drive of the disk drive pair with the hot spare solid state disk drive, thereby pairing said hot spare solid state disk drive with said hard disk drive, said hot spare solid state disk drive including the copied data from the solid state disk drive.

19. A computer-readable medium as claimed in claim 16, wherein the solid state disk drive is a Not and (NAND) flash drive.

20. A computer-readable medium as claimed in claim 16, wherein the RAID configuration is a Level 1 RAID configuration (RAID 1 configuration) and the RAID disk drive pair is a RAID 1 disk drive pair.
